(19) United States
(12) Patent Application Publication
(10) Pub. No.: US 2007/0194155 A1
(43) Pub. Date: Aug. 23, 2007

(54) BROADCAST SPREADER WITH RATE CONTROL SYSTEM

(76) Inventor: Jeffrey D. Kendall, Laurel, MD (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/677,836

(22) Filed: Feb. 22, 2007

Related U.S. Application Data
(63) Continuation-in-part of application No. 11/488,496, filed on Jul. 18, 2006.
(60) Provisional application No. 60/700,156, filed on Jul. 18, 2005.

(51) Int. Cl. A01C 15/00; A01C 17/00

(52) U.S. Cl. 239/650; 239/661; 239/681

(57) ABSTRACT

A rate control system for a material spreader for maintaining a uniform dispersal or spreading of material such as fertilizer or similar material. The rate control system works with a spreader having a moveable control gate positioned at the hopper output orifice. The control system moves the spreader control gate between a closed position and an adjustably open position. The degree that the control gate is opened is controlled by a linear actuator that operates in one direction to contact a first limit switch, defining the closed position, and operates in the other direction to contact a second limit switch, with the point at which the second limit switch is contacted being adjustable.

### REFERENCE TO RELATED APPLICATIONS

This application is a continuation-in-part application from application Ser. No. 11/488,496, filed Jul. 18, 2006, which claims the benefit of Provisional Application Ser. No. 60/700,156, filed Jul. 18, 2005, which are hereby incorporated by reference in their entirety.

### BACKGROUND

The lawn care or landscape maintenance industry uses spreaders to apply products, such as fertilizer and other granulated material, to maintain and promote a healthy lawn, for example. Often the landscaper or lawn care worker must apply these products to a lawn in a climate that changes over the course of a calendar year. For example, in some geographic areas the spring season may have a climate with relatively low humidity and low temperatures compared to its summer season that may have a climate with relatively high humidity and high temperatures. The level of humidity typically affects the fertilizer or granulated material in the spreader such that the fertilizer or granulated material will clot or clump in the spreader, thereby making it difficult for the material to pass smoothly through the spreader to be distributed onto a lawn. Often spreaders have a shut-off plate or control gate that controls the rate that a fertilizer is applied to a lawn. The shut-off plate may be attached to, and controlled by, a solenoid which may work in combination with a spring. However, it is often difficult to balance the rate of closure of the shut-off plate spring with the opening power of the solenoid in both humid climates (where the fertilizer becomes sticky) and dry climates (where the fertilizer remains granular). In these situations, too much solenoid power, or too weak a spring, may prevent the spring from efficiently closing the shut-off plate in dry weather, while too little solenoid power, or too strong a spring, may not allow the shut-off plate to open properly in humid weather. Either situation may result in an improper amount of material being spread or applied. For that reason, spreaders having a solenoid and spring combination have not proven to be completely satisfactory, and improved means of operating a shut-off plate on spreaders is needed. It is desirable that a spreader be capable of delivering an accurate amount of fertilizer or other material with repeatable opening and closing of the shut-off plate in any environment.

### SUMMARY

One embodiment of the present disclosure includes a spreader for applying a granulated material or fertilizer where the spreader includes a control gate or shut-off plate operated by a rate control system that moves the control gate to facilitate an accurate application of fertilizer from the spreader to the lawn.

In another embodiment of the disclosure, the control gate of the spreader is variably adjustable to accurately control the application of material from the spreader. In other embodiments, the rate control system is adaptable to be installed on existing spreaders to provide added functionality.

Related objects and advantages will become apparent from the description below.

### BRIEF DESCRIPTION OF THE DRAWINGS

FIG. 1 is a perspective view of a material spreader constructed in accordance with an embodiment of the disclosure, illustratively shown as being mounted to a riding mower.

FIG. 2 is a side elevational view of a spreader constructed in accordance with an embodiment of the disclosure, illustratively shown as being attached to the rear of a vehicle.

FIG. 3 is a side elevational view of the spreader shown in FIG. 2, illustrating additional details.

FIG. 4 is a bottom plan partial cross-sectional view of the spreader shown in FIG. 3, taken along line 4-4.

FIG. 5 is a side elevational cross-sectional and schematic view of the spreader shown in FIG. 4, taken along line 5-5.

FIG. 6 is a top plan view of a portion of a spreader constructed in accordance with another embodiment of the disclosure.

FIG. 7 is a portion of the schematic wiring diagram for a spreader rate control apparatus constructed in accordance with an embodiment of the present disclosure.

### DESCRIPTION OF THE ILLUSTRATED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles of the disclosure being contemplated as would normally occur to one skilled in the art to which the disclosure relates.

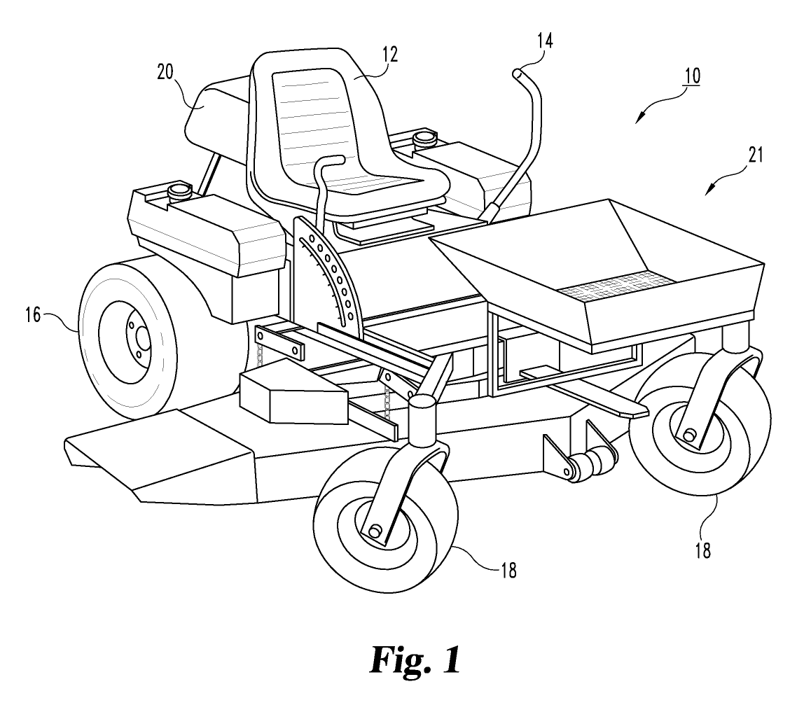

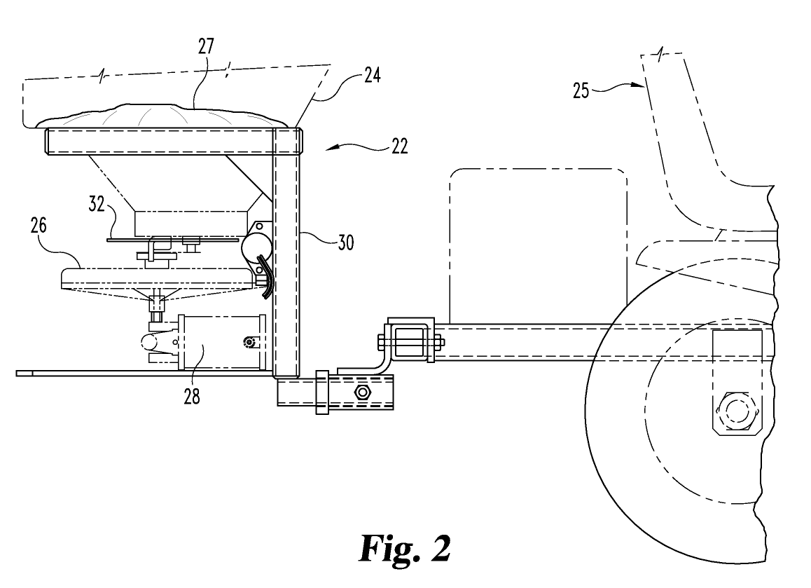

Referring to FIG. 1, there is illustratively shown a zero turning radius riding mower 10, having a seat 12, with a steering control mechanism 14. Mower 10 is illustratively supported by one or more back wheels 16 and one or more front wheels 18. In the embodiment shown, a liquid sprayer 20 is mounted to the back or rear of mower 10 and a spreader 21, constructed in accordance with one embodiment of the disclosure, is mounted to the front of mower 10. As an example, spreader 21 may be used for the application of granular type fertilizer or seed, as only two non-limiting examples, to the surface of a lawn or other planted areas, although other uses and applications of spreader 21 are of course possible. Details of the construction and operation of various embodiments of the disclosure will be explained in greater detail with reference to FIGS. 2 through 8.

In the embodiment shown in FIG. 2, a spreader 22 is illustrated as being pulled behind a vehicle 25, which may be a tractor, riding mower, or some other vehicle adapted for pulling devices such as spreader 22. The description below with respect to spreader 22 is equally applicable to spreader 21 of FIG. 1 and merely illustrates alternate ways in which a spreader may be utilized with different types of vehicles.

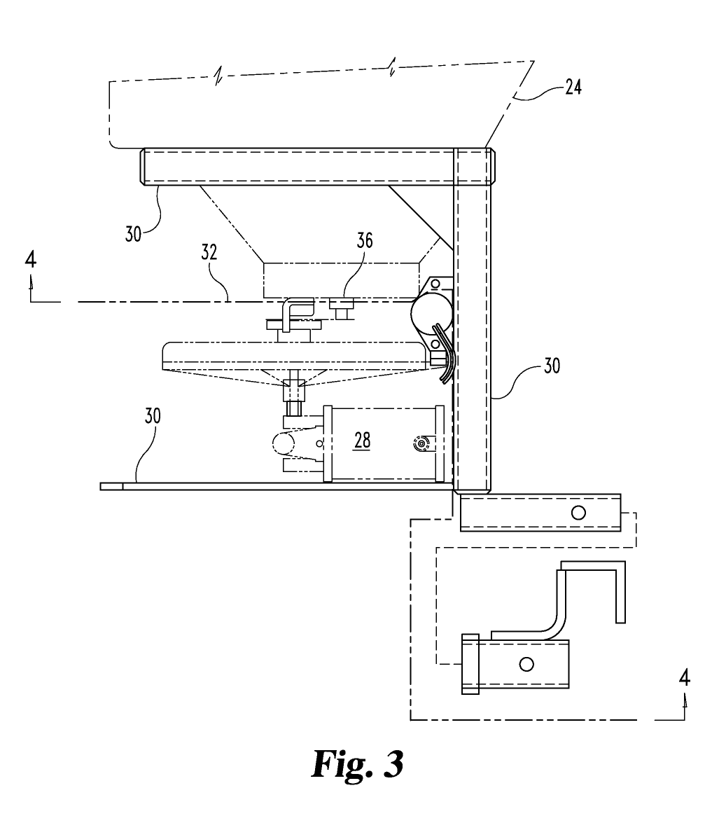

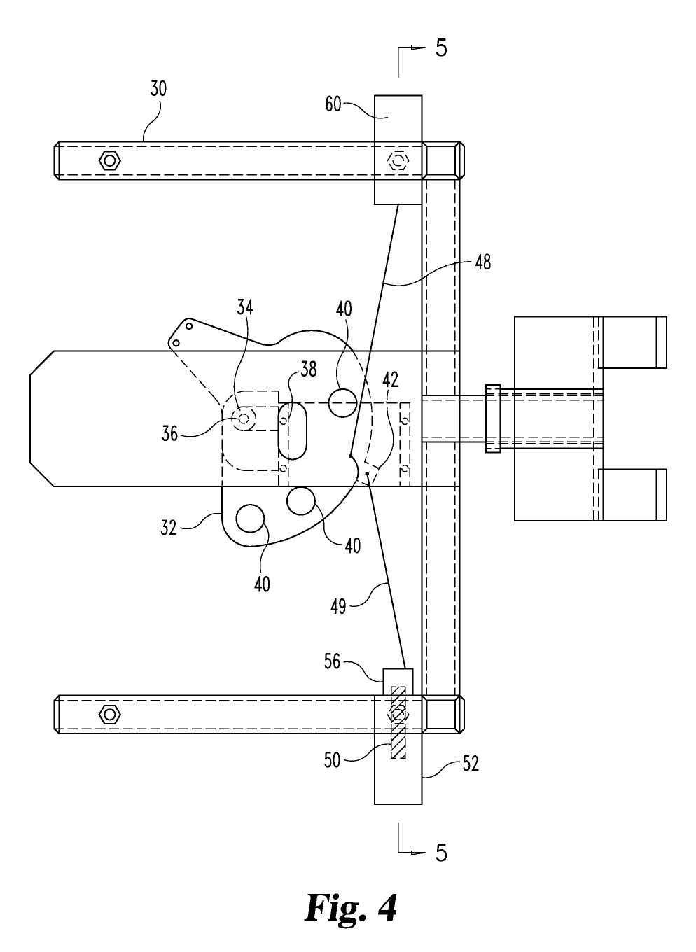

As can be seen in FIGS. 2 and 3, spreader 22 incorporates a hopper 24 containing a quantity of material 27, which may be fertilizer or seed, as described above, for example. Below hopper 24 is positioned a material distribution blade or paddle assembly 26. Distribution blade assembly 26 is illustratively operated by a motor 28, located at the underside of assembly 26, which spins blade or paddle assembly 26 to spread or scatter fertilizer or whatever material is placed in hopper 24 as it descends by gravity from hopper 24. Support brackets 30 are shown that structurally support hopper 24 and motor 28. Spreader 22 also incorporates a control gate or shut-off plate 32 located along the underside of hopper 24. As can be seen in FIG. 4, control gate 32 includes a number of apertures. Aperture 34 of control gate 32 provides a pivot point for control gate 32 by pivotally connecting control gate to a mount 36 that extends from the underside of hopper 24 through aperture 34. A clearance slot 38 is also shown as being formed in control gate 32, which allows access for the insertion of an agitator (not shown), which may be utilized to transmit vibrations to hopper 24 to assure that the granular or seed like material in hopper 24 properly flows from hopper 24 to ensure uniform broadcasting of the material. Apertures 40 are designed to align with similarly positioned apertures or discharge ports or holes located in the bottom of hopper 24, so that when control gate 32 is pivoted into an open or operating position, the alignment of these apertures 40 with the openings at the bottom of hopper 24 allows material (e.g., fertilizer) to fall out of hopper 24 for dispersal by blade or paddle assembly 26.

There is also shown a tab 42 to which control cables or rods 48 and 49 are mounted for the purpose of moving and holding control gate 32 between open and closed positions. This assures that proper alignment of the various apertures is made, to allow for proper dispensing or dispersing of the material 27 in hopper 24. Tab 42 and control gate 32 may rotate about mount 36 so as to provide for either full or partial alignment of the apertures 40 with the discharge ports or holes provided at the bottom of hopper 24, so as to control the rate of dispensing of the granular fertilizer or similar material during usage of spreader 22.

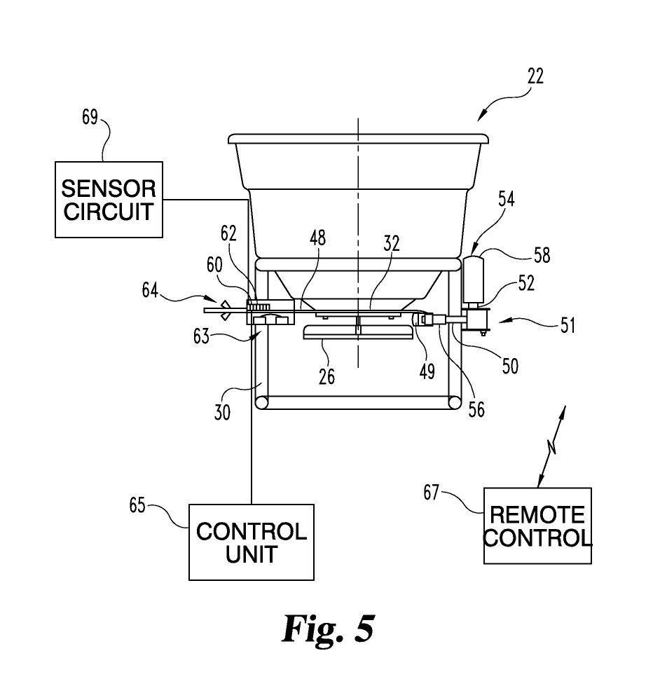

In the illustrated embodiment shown in FIG. 5, control gate 32 is operated by the use of a metering rate control system 51. Metering rate control system 51 incorporates a linear actuator 52 (such as might be used to position seats in vehicles) which comprises a motor assembly 54, rod 50, and collar 56. In one form, linear actuator 52 operates from a 12-volt power supply (e.g., battery or alternator of mower 10 or vehicle 23. As shown, rod 50 is a threaded rod or screw connected to a mating threaded collar 56. Threaded rod 50 is moveable in translational motion relative to both a housing 58 in which motor assembly 54 is mounted or fastened, and to collar 56. Collar 56 can be attached to control gate 32 by various means such as by cable 49, for example. Linear actuator 52 and housing 58 are supported by one or more of support brackets 30.

Metering rate control system 51 is illustratively shown as incorporating a potentiometer 60, or other suitable type of transducer, fastened to a second housing 62. Housing 62 is also supported by one or more of support brackets 30. Potentiometer 60 is connected to control gate 32 by cable 48 and operates via one or more switches 63. Switches 63 are illustratively shown as comprising electromechanical contact switches, but other types of switches would of course by equally acceptable. Potentiometer 60 allows a control unit 65 to collect information regarding the position of actuator 52 through a variable control linkage 64. Variable control linkage 64 is illustratively connected to control gate 32 via cable 48. In one embodiment, variable control linkage 64 and switches 63 allow control gate 32 to be properly positioned or regulated from a remote location via a handheld remote control device 67, or via a hand or foot-operated mechanism attached to vehicle 25, for example. Variable control linkage 64 receives a signal from potentiometer 60 that correspondingly provides a control signal to linear actuator 52 and motor assembly 54. A position sensor such as an encoder coupled to linear actuator 52 or to rod 50 may provide a position signal to control linkage 64. Variable control linkage 64 determines the stopping position of motor assembly 54 which translates to a controlled opening of control gate 32. Thus, metering rate control system 51 is able to accurately control the force produced by linear actuator 52 by controlling the stopping position of motor assembly 54 and thus the control gate displacement is able to be accurately determined and maintained. Metering rate control system 51 allows a user to accurately position control gate 32 to control the amount of fertilizer or other material that applied to a lawn surface, for example.

In another embodiment, monitor or feedback sensor circuit or system 69, shown in FIG. 5 as being illustratively coupled to potentiometer 60, may monitor ambient temperature and/or humidity, the moisture content of the material in hopper 24, the granularity of the material, and the actual dispersion rate, to name only a few non-limiting examples, to control the operation of control gate 32 in order to ensure uniform material spreading regardless of weather or other operating conditions of spreader 22.

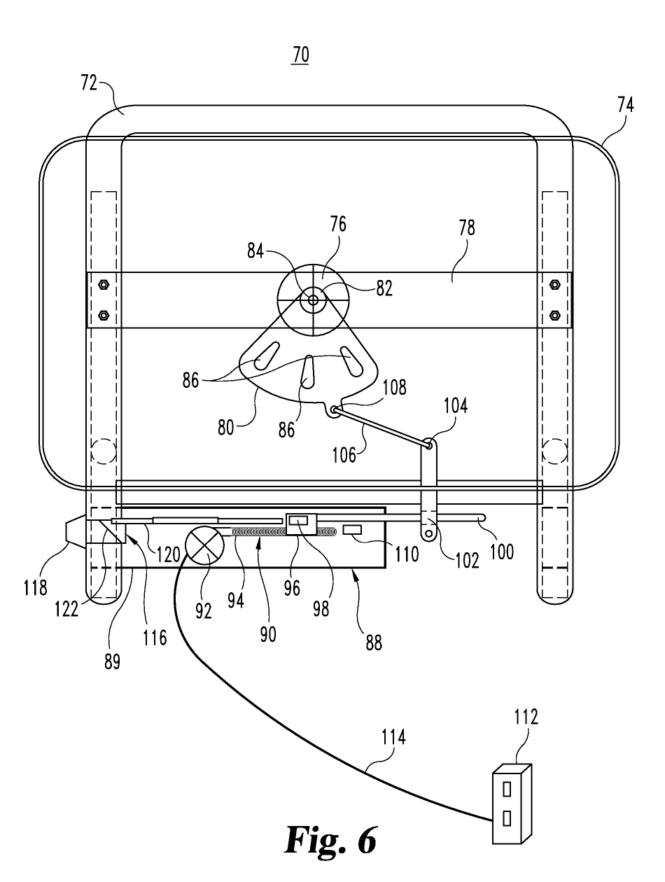

Referring to FIG. 6, there is shown a material spreader 70 having a support structure 72 to which is mounted a hopper 74. A motor 76, which may be of the impeller type, is illustratively shown as being located within hopper 74 for rotating material dispersion blades or paddles (not shown). Motor 76 is illustratively shown as being mounted to support member 78, which is attached to support structure 72. Also shown in FIG. 6 is a hopper control gate 80, which may be positioned along the underside of hopper 74, or within hopper 74 itself. Control gate 80 is illustratively shown as mounted such that pivot aperture or hole 82 fits over mounting boss or post 84, but other means and mounting structures are of course possible. Control gate 80 therefore pivots around the pivot point established by aperture 82 and mounting boss 84. Control gate 80 also incorporates apertures, holes, or orifices 86 which, when aligned with similar apertures, holes, or orifices (not shown) located at the bottom of hopper 74, allow the material contained in hopper 74 to flow out of hopper 74 to be dispersed by the rotating dispersing blades or paddles. The degree to which the apertures 86 are in alignment with the apertures or holes in hopper 72 determines the rate at which the material in hopper 72 is applied.

In accordance with an embodiment of the present disclosure, the position of control gate 80 is determined by an application rate control system 88. Rate control system 88 incorporates a housing 89, within which is positioned a linear actuator 90, comprising a motor 92 and an actuating rod 94. A carriage 96 is mounted on actuating rod 94. Carriage 96 incorporates a limit switch 98 and a positioning rod 100. Bracket or collar 102 is mounted on positioning rod 100 and illustratively incorporates an aperture or hole 104 through which cable or rod 106 attaches to bracket 102. Other means of attaching or mounting cable or rod 106 to bracket 102 are of course possible. The other end of cable or rod 106 is shown as being illustratively attached to control gate 80 via aperture or hole 108. A second limit switch 110 is shown mounted within housing 89. Motor 92 is illustratively shown as being operated by switch 112 via wire 114, although other means of communicating between switch 112 and motor 92, including wireless remote control, is possible and contemplated by this disclosure. A material rate flow control 116, comprising an adjustment knob 118 and a control rod 120, is also mounted to housing 89 of rate control system 88. Adjustment knob 118 is shown as illustratively having a linear inclined surface 122 which adjusts the lateral (i.e., in or out) position of control rod 120 such that the distal end of control rod 120 is moved closer to, or away from, limit switch 110, depending upon which way knob 118 is turned. Knob 118 is illustratively shown as being able to be turned of the order of 180°.

The operation of motor 92 moves carriage 96 along rod 94. In the situation where carriage 96 is moving in a direction away from control rod 120, motor 92 is caused to stop operation when carriage 96 contacts limit switch 110. This represents a fully closed position or condition of control gate 80. When carriage 96 is moving in the other direction, i.e., toward control rod 120, limit switch 98 will eventually contact the end of control rod 120, thereby causing motor 92 to stop operation. When knob 118 is adjusted so that control rod 120 is positioned as far from limit switch 110 as possible (i.e., in a retracted position), the contact of limit switch 98 with the end of control rod 120 will represent a fully open position or condition of control gate 80. Intermediate linear adjustment of knob 118 will move control rod 120 in such a way as to allow control gate 80 to be opened by a fixed, determinable amount, such that the degree of openness of control gate 80 can be accurately controlled. Indicia (e.g., ⅛, ¼, ½, etc.) may be printed on knob 118 to provide a visual feedback of the degree of opening being provided to control gate 80, although the linear operation of knob 118, via inclined surface 122, allows for any amount of openness of control gate 80.

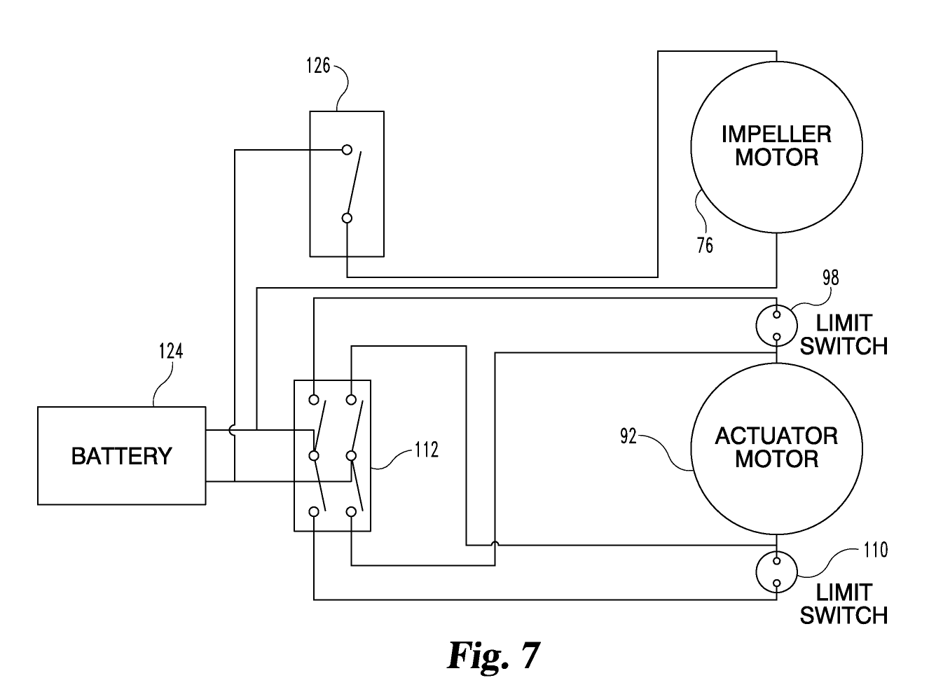

FIG. 7 illustrates a portion of the schematic wiring diagram for spreader 70 incorporating rate control system 88. Power for motor 76, illustratively shown as an impeller motor in FIG. 7, and actuator motor 92, is provided by battery 124. Switch 126 is illustratively provided to control the operation of motor 76 located in hopper 74 of spreader 70. Switch 112 is illustratively shown as a double-pole double-throw switch that causes motor 92 to move control gate 80, via rate control system 88, toward an open or a closed position, depending upon the switch position selected. Limit switches 98 and 110 are illustratively shown as normally-closed contact switches, but other switch types and other means for controlling the operation of motor 92 are possible and are considered to be within the scope of this disclosure.

Rate control system 88 may be incorporated in the design and construction of independent spreaders, or in vehicle-spreader combinations, or system 88 may be manufactured and sold as a retrofit or aftermarket module that can be installed on spreaders or spreader vehicles to provide accurate flow rate control at the touch of a button or switch. Feedback sensor circuits such as those described in connection with spreader 22 may be used as well to provide environmental feedback to system 88 to further refine and control the operation of system 88.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed is:

1. A spreader comprising:
a hopper for holding a quantity of material, said hopper having an aperture disposed in the bottom of said hopper through which said material passes;
a control gate disposed adjacent to said aperture for controlling the size of said aperture; and
a control mechanism incorporating an electrically operable adjustment apparatus for controlling the operation of said control gate between a closed condition and an open condition, the degree of openness being determined by said adjustment apparatus.

2. The spreader described in claim 1, wherein said control mechanism comprises a linear actuator and first and second limit switches.

3. The spreader described in claim 2, wherein said first limit switch cooperates with said linear actuator to define a closed condition for said control gate.

4. The spreader described in claim 2, wherein said second limit switch cooperates with said linear actuator to define an open condition for said control gate.

5. The spreader described in claim 4, wherein the operation of said linear actuator is adjustable to control the degree of openness of said open condition.

6. A control mechanism for a spreader incorporating a movable material control gate comprising:
a first limit switch having a fixed position;
a linear actuator having a positional member, said positional member moving in response to operation of said linear actuator, wherein movement of said positional member contacts said first limit switch to define a closed position of said material control gate;
a second limit switch mounted to said positional member; and
adjustment apparatus adjustable through a positional range, wherein movement of said positional member causes said second limit switch to contact said adjustment apparatus to define an adjustably open position of said material control gate.

7. A method for operating a spreader comprising:
providing a quantity of material in a hopper;
providing an opening in said hopper through which said material flows; and
providing a control gate for linearly controlling the size of said opening, wherein said control gate is electrically controlled between a closed position and an adjustably open position.
